(19) United States
(12) Patent Application Publication
(10) Pub. No.: US 2024/0057222 A1
(43) Pub. Date: Feb. 15, 2024

(54) PTC Heating Device

(71) Applicant: Eberspacher catem GmbH & Co. KG, Herxheim (DE)

(72) Inventors: Kurt Walz, Hagenbach (DE); Rüdiger Freitag, Landau (DE); Ahmad Asafi, Karlsruhe (DE)

(21) Appl. No.: 18/232,653

(22) Filed: Aug. 10, 2023

(30) Foreign Application Priority Data
Aug. 11, 2022 (DE) 10 2022 120 360.3

(51) Int. Cl. H05B 3/06

(52) U.S. Cl. CPC H05B 3/06; H05B 2203/016; H05B 2203/02

(57) ABSTRACT

A PTC heating device has a heating cell with at least one PTC element and conductor elements provided on opposite sides of the PTC element. The conduct elements form contact surfaces for the electrical contacting of the PTC elements, are electrically connected to the PTC element, and are to be assigned different polarities. The conductor elements also are provided with an electrical insulation on their side opposite the PTC element. A metallic housing which accommodates the heating cell is connected to the insulation in a heat-conducting manner Each of the conductor elements is provided with at least one through-hole by which the electrically conductive surface of the conductor elements is reduced.

### BACKGROUND OF THE INVENTION

### 1. Field of the Invention

The present invention relates to a PTC heating device with a plurality of PTC elements arranged one behind the other at a distance in a longitudinal direction and conductor elements provided on opposite sides of the PTC elements, which form contact surfaces for the electrical contacting of the PTC elements.

### 2. Background of the Invention

Such a PTC heating device is known, for example, from EP 1 768 457 A1. In this prior art, several PTC elements are provided one behind the other in the longitudinal direction of an elongated heating rod, and in part also transversely thereto. Contact sheets abut on opposite main side surfaces of the PTC elements. These are covered with an insulating layer on the outer surface opposite the PTC elements. The insulating layer is connected to the position frame by an adhesive bead in a sealing manner. Thus, the current-carrying parts of the PTC heating device are protected from the environment.

Covering the conductor elements on the outside, which in the prior art are formed by contact sheets, enables the PTC heating device to be operated with high voltage without the power current introduced into the PTC element for this purpose being exposed on the outside of the PTC heating device, which can lead to health hazards in the scope of repairs to a PTC heating device accommodating the PTC heating device.

The PTC heating device according to the present invention, as well as according to the generic prior art, is commonly used as a component of a PTC heating device which is usually used in a vehicle for heating a medium. The medium can be a liquid medium which circulates in a heat exchanger circuit inside the vehicle. Such a configuration of the PTC heating device is particularly conceivable in an electrically driven vehicle. However, the PTC heating device can also heat air, as documented by the aforementioned prior art. In such a case, metallic radiator layers abut against the insulation on the outside.

In the case of a liquid heater, the insulating layers can form the outer surface of the PTC heating device.

In particular for sealing the parts to which the power current is applied, especially in high-voltage applications, it is also known to arrange the above-mentioned elements inside a metallic housing. The outer surface of the metal housing that dissipates the heat usually abuts directly on the outside against the insulating layer. This is because for an effective operation of the PTC heating device, a heat conduction path from the PTC element to the outside of the PTC heating device is necessary. Because otherwise, the PTC elements can only develop a reduced performance due to their self-regulating properties.

The PTC elements used in the PTC heating device according to the invention are usually ceramic components which are provided with a metallization on both sides. The conductor elements abut against this metallization. The conductor elements can abut against the main side surface of the PTC element. This main side surface is several times larger than an end side surface, which usually connect the main side surfaces of the cuboid PTC element and accordingly define the height of the PTC element. However, the conductor elements can also be electrically conductively connected to opposite end faces and/or main side surfaces of the PTC element.

In particular in high-voltage applications, the conductor elements, which are usually formed from sheet metal, and the envelope provided on the outside for this purpose represent a type of plate capacitor which stores energy. In case of contact with the PTC heating device by a person, for example in the scope of repairing an electrically operated vehicle, there is a risk of electric shock. This electric shock occurs due to the parasitic c-capacitance of the aforementioned structure.

### SUMMARY

The present invention aims to provide a PTC heating device of the type described introductorily, which can be operated with increased electrical safety.

In order to solve this problem, the present invention provides a PTC heating device having a heating cell that may be of in a generally known construction. This heating cell comprises at least one PTC element, which may be provided in a position frame. On opposite sides of the PTC element, conductor elements are provided, usually in the form of contact sheets made of an electrically conductive material such as aluminum or copper. These conductor elements form contact surfaces for the electrical contacting of the at least one PTC element. Usually, the at least one PTC element regularly abuts directly against the respective contact surface of the corresponding conductor element. Here, too, the conductor elements are usually located on opposite sides and accommodate the PTC element between them. The PTC elements usually have a metallization interacting with the contact surface, which is coated onto the ceramic PTC element. Each individual PTC element is electrically connected to the conductor elements. The conductor elements are to be assigned different polarities. Via these conductor elements, the power current is fed to the PTC element.

In this context, the present invention in particular focuses on a high-voltage application in which the heating cell is operated with current that has an increased voltage compared to the usual on-board voltage of a motor vehicle, which is regularly 12 volts. For example, the voltage may be 48 volts or more. In particular, it is intended to operate the PTC heating device in an electric vehicle with a power current of higher voltage. Thus, there is an electrical insulation on the outside of the respective conductor element. This electrical insulation is in heat-conducting contact with surfaces of a metallic housing which accommodates the heating cell.

Thus, the conductor elements usually abut against the heat-emitting surfaces of the housing formed by the metallic housing with the electrical insulation interposed. These surfaces are usually plane-parallel, but in any case parallel to the conductor elements, which causes the problem of parasitic capacitance.

The parasitic c-capacity is calculated from C=εr·ε₀ A/d, wherein εᵣ is the relative permittivity of the dielectric, in this case of the electrical insulation; ε₀ is the electric field constant; A the opposing surfaces, which in this case correspond to twice the surface of the conductor element, and d=distance between the metallic housing or the heat-emitting surface segments thereof and the conductor element.

The present invention now proposes to reduce the surface of the conductor elements. In doing so, the dimension of the heating cell as a whole is not reduced. Rather, the conductor element, more typically both conductor elements, are usually provided with at least one through-hole in the form of a recess or indentation through which the electrically conductive surface of the conductor elements is reduced.

In the case of PTC elements arranged at a distance one behind the other in the longitudinal direction, a recess or indentation can be provided between the contact surfaces and accordingly between the individual PTC elements. In the following, a recess is a hole which is completely surrounded by the material of the conductor material. A bulge opens to an edge of the conductor element. Between the individual contact surfaces, holes can accordingly be provided in the form of punched holes or through-holes of, for example, an expanded metal or a metal grid or metal mesh. The conductor element can also be cut out from the longitudinal side to form an indentation. Between the individual contact surfaces, the electrically conductive surface of the conductor elements should be chosen to be as small as possible. Thus, only thin webs can remain between adjacent contact surfaces. The dimension of these webs is chosen with regard to the fact that a heating cell can still be handled in a process-safe manner in the scope of assembly and that the structural integrity of the heating cell is still ensured by the conductor elements, which enclose several PTC elements between them, for example in the manner of a heating rod.

The conductor elements can be formed by sheet metal strips provided with through-holes. The sheet metal strips can be configured as perforated sheet metal before processing to form the heating cell. The conductor elements can also be formed by electrically conductive sheet metal which has been further processed into expanded metal. As previously mentioned, the conductor elements can also be formed by a metal grid or wire mesh.

Corresponding conductor elements provided with through-holes are disclosed, for example, in DE 10 2019 204 472 A1 and DE 10 2017 223 782 A1, which originate from the present applicant. In the prior art mentioned first, no heating cell in the actual sense is provided in a housing. Rather, the conductor elements provided with through-holes are applied in direct electrical contact against the PTC element and enclosed in a ceramic housing. Here, the problem of a parasitic c-capacitance does not exist.

DE 10 2017 223 782 A1 merely discloses a braid provided with through-holes with the aim of forming contact points to the PTC element by means of undulating strands of the braid, thus providing a defined and punctual electrical contact between the braid and the PTC element. However, the corresponding heating cell is not provided in a metallic housing, so that the problem of parasitic c-capacitance does not exist with this PTC heating device.

However, the last-mentioned prior art proposes to fill any free spaces in the plane of the layered structure accommodated by the conductor element, which is formed by the two electrical insulations, the conductor elements and the at least one PTC element provided therebetween, with a good heat-conducting mass, so that the heat conductivity of the heat-conducting path from the PTC element to the outside of the electrical insulation is increased. The present invention takes up this suggestion with a further development. Reference can be made to the measures described in DE 10 2017 223 782 A1 for increasing the heat conductivity in the recesses. In the present invention, a corresponding mass can also be provided in the recesses.

### BRIEF DESCRIPTION OF THE DRAWINGS

Further details and advantages will be apparent from the following description of embodiments in conjunction with the drawing. Therein:

FIG. 1 shows a perspective longitudinal sectional view of an embodiment of a PTC heating device;

FIG. 2 shows a top view of a first embodiment of a conductor element with PTC elements resting on it;

FIG. 3 shows a top view of a second embodiment of a conductor element, and

FIG. 4 shows a top view according to FIG. 3 of a third embodiment of a conductor element.

### DETAILED DESCRIPTION

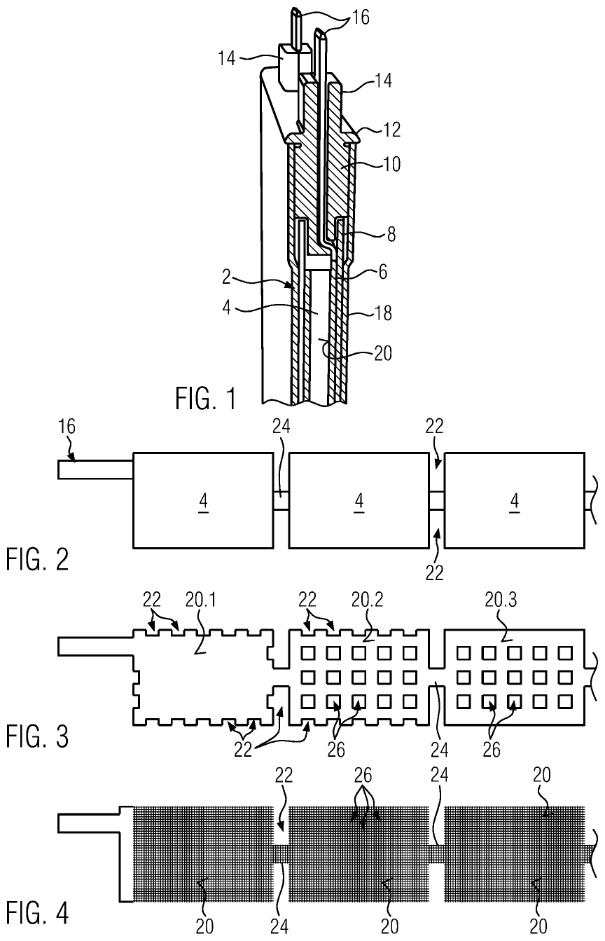

FIG. 1 shows a perspective longitudinal sectional view of an upper part of a PTC heating device of rod-shaped configuration with a heating cell 2 comprising a plurality of PTC elements 4 provided one behind the other in the longitudinal direction of the PTC heating device, wherein FIG. 1 shows only one of the PTC elements 4. On opposite main side surfaces of the PTC elements 4, conductor elements 6 presently abut in the form of contact sheets. These conductor elements 6 are electrically contacted against the main side surfaces of the PTC elements. On the outer surface of the conductor elements 4 opposite the PTC element 4, electrical insulations 8 are provided in each case. Presently, this is a hybrid insulation consisting of a ceramic layer with a film applied thereon, which is already described in EP 1 768 457 A1. Reference sign 10 characterizes a positioning frame which may have a plurality of accommodations provided one behind the other in the longitudinal direction of the heating cell, each accommodating at least one of the PTC elements 4 therein, and accordingly spaces apart and positions the PTC elements 4 in a predetermined manner in the longitudinal direction of the heating cell 2. The free end of the positioning frame 10 is configured as an end cap and forms a widened edge 12, which is surmounted by connecting pieces 14, which, like the edge 12, are formed in one piece by the positioning frame 10. The two connecting pieces 14 position, hold and accommodate connection tongues 16, which are formed by the respective conductor elements 4 and serve to make contact with the heating cell 2.

The previously described heating cell 2 is accommodated in a metallic housing 18. The metallic housing can, for example, be formed as a flat tube closed on the underside. It is also possible to configure the housing 18 by two metallic shells, as basically known from EP 2 607 808 A1. As FIG. 1 illustrates, the housing 18 abuts the plug-side end of the position frame 10, wherein the edge 12 abuts against the housing 18 on the end face.

At the height of the PTC elements 4, the housing 18 is deformed so that the main side surfaces of the housing 18 are directly applied in a heat-conducting manner against the electrical insulation 8. The parallelism of the metallic surfaces of the housing 18 and the conductor elements 6 spaced apart solely via the insulation 8 cause the problem of parasitic c-capacitances.

FIGS. 2-4 show different variants of how the electrically conductive surface of the conductor elements can be reduced.

FIG. 2 shows three PTC elements 4 provided one behind the other in the longitudinal direction, each of which rests on contact surfaces which are characterized in FIGS. 1, 3 and 4 by reference signs 20 and are formed by the conductor elements 8. As FIG. 2 illustrates, the conductor element 6, which can be seen there only between the PTC elements and laterally next to them, is provided between the individual PTC elements 4 with through-holes in the form of indentations 22. Accordingly, the conductor element 6 is reduced with regard to its surface between the PTC elements 4. Between the individual PTC elements 4 there remains only a web 24, which is considerably thinner than the width of the actual conductor element 6 or the contact surfaces 20.

In the embodiment shown in FIG. 3, the conductor element 8 is formed by a contact sheet. The left-hand contact surface 20.1 has a plurality of indentations by which the contact surface 20 is reduced with regard to its surface. This leaves sufficient surface area for electrical contacting of the PTC element 4.

The central contact surface 20.2 of the embodiment according to FIG. 3 is formed by a sheet metal segment which is provided with uniform rectangular through-holes in the form of recesses 26. This also results in indentations 22 at the longitudinal frame edges.

The contact surface 20.3 shown on the right has a slightly different perforated pattern.

In the embodiment according to FIG. 4, the contact surfaces 20 are formed by a wire mesh. Here, too, the individual contact surfaces 20 are connected solely by webs 24.

Obviously, due to the indentations or through-holes within the contact area 20, surface areas of the electrically conductive material of the conductor elements 8 have been removed. These removed surface areas can no longer contribute to the parasitic c-capacitance, so that the problem of a corresponding capacitive charge on the outside of the housing is reduced. As previously described, the removed surface areas of the conductor elements are filled with a good heat-conducting mass, which is usually electrically insulating. Due to the electrically insulating properties of the mass, the problem of parasitic c-capacitance is further reduced without impairing the good heat extraction from the PTC element 4 to the outside of the housing 18. A corresponding mass can be applied specifically to a perforated pattern of a perforated sheet, expanded metal or even mesh, for example, by doctoring or screen printing.

What is claimed is:

1. A PTC heating device comprising:
a heating cell including at least one PTC element and conductor elements which are provided on opposite sides of the PTC element, wherein the conductor elements form contact surfaces for the electrical contacting of the PTC elements, are electrically connected to the PTC element, and are to be assigned different polarities, and wherein each of the conductor elements is provided with an electrical insulation on a side thereof opposite the PTC element; and
a metallic housing which accommodates the heating cell and which is connected to the insulation in a heat-conducting manner, wherein each of the conductor elements has at least one through-hole located therein

2. The PTC heating device according to claim 1, wherein a plurality of PTC elements are arranged one behind the other at a distance in a longitudinal direction, wherein conductor elements are provided on opposite sides of the PTC elements, and wherein a width of the conductor elements between the PTC elements is reduced by the at least one through-hole.

3. The PTC heating device according to claim 2, wherein the contact surfaces of adjacent PTC elements are each interconnected by a single tapered web.

4. The PTC heating device according to claim 1, wherein the conductor elements are formed by sheet metal strips provided with through-holes.

5. The PTC heating device according to claim 1, wherein the conductor elements are formed by a metal grid or wire mesh.

6. The PTC heating device according to claim 1, wherein an electrically non-conductive mass is introduced into the through-holes of the conductor elements within the contact surface.
